(19) United States
(12) Patent Application Publication
(10) Pub. No.: US 2006/0096437 A1
(43) Pub. Date: May 11, 2006

(54) Integrated glass cutting and laser marking table

(75) Inventor: Phillip David Plant, Butler, PA (US)

Correspondence Address: BLYNN L. SHIDELER;THE BLK LAW GROUP, 3500 BROKKTREE ROAD, SUITE 200, WEXFORD, PA, 15090, US

(73) Assignee: Billco Manufacturing, Inc., Zelienople, PA (US)

(21) Appl. No.: 11/268,955

(22) Filed: Nov. 8, 2005

Related U.S. Application Data
(60) Provisional application No. 60/626,064, filed on Nov. 8, 2004.

(51) Int. Cl. B26D 3/08

(52) U.S. Cl. 83/879

(57) ABSTRACT

An integrated glass cutting and laser marking table includes a main table, at least one bridge, at least one carriage, a glass cutting head and laser marking unit. Each bridge extends across the main table, wherein each bridge is movable along the length of the table. Each carriage is moveable along the length of each bridge in a direction generally transverse to the table length. The cutting head is mounted on a carriage with the cutting head selectively engaged with the work piece. The laser marking unit is also mounted on a carriage and with the laser marking unit selectively engaged with the work piece. One embodiment has separate bridges and carriages, a second embodiment has a common bridge and separate carriages, and a third embodiment has a common bridge and a common carriage. The laser marking unit may be retrofitted to existing cutting tables.

### RELATED APPLICATIONS

The present application claims the benefit of provisional application Ser. No. 60/626,064, filed Nov. 8, 2004 entitled “Integrated Glass Cutting and Laser Marking Table”.

### BACKGROUND OF THE INVENTION

1. Field of the Invention

The present invention relates to glass cutting and marking systems, and more particularly to an integrated glass cutting table and laser marking table for glass work pieces.

2. Background Information

In the glass processing industry, a conventional glass cutting table comprises an air float table for transporting the glass work piece to be cut and a bridge extending across the air float table. A vacuum or vent in the air float table will hold the work piece for scoring, also known as cutting. The bridge is movable along the length of the air float table. The bridge typically includes a carriage holding a glass work piece cutting head, also called a glass scoring head, for processing or cutting the glass work piece according to a predetermined pattern. The carriage is moveable along the length of the bridge transverse to the length of the air float table. The carriage will have a movement mechanism, such as a solenoid, for vertically moving the scoring head into and out of engagement with the work piece. The glass work pieces must be fed onto and off of the glass cutting table and must be aligned on the glass cutting table. These existing glass cutting tables have been sold by an industry leader Billco Manufacturing, Inc. and are known to those of ordinary skill in the art.

Laser marking devices have been used extensively for marking a wide range of products, including glass work pieces. These laser marking devices have been used to engrave or etch logos, decorative designs, item tracking elements such as bar codes and the like into glass work pieces. These existing laser marking devices have been incorporated into glass processing lines, however the incorporation of a separate station has not always been efficient. When retrofitting an existing processing line to include a new laser marking station, the new station may be placed off to the side of the existing line where the glass work pieces have to be diverted. Even when the line can accommodate an additional marking station (such as by eliminating or minimizing a conveying table), the incorporation does not provide an efficient solution.

The object of the present invention is to overcome the aforementioned difficulties with the prior art and to provide an integrated glass cutting and laser marking table. A further object of the present invention is to provide a laser marking system which can be easily retrofitted to existing glass cutting tables.

### SUMMARY OF THE INVENTION

The above stated objects achieved with an integrated glass cutting and laser marking table according to the present invention. The glass cutting and laser marking table according to the present invention includes a main table, such as an air float table, for transporting the glass work piece to be cut; at least one bridge extending across the main table, wherein each bridge is movable along the length of the air float table; at least one a carriage moveable along the length of each bridge in a direction generally transverse to the length of the main table; a glass work piece cutting head mounted on a carriage, the cutting head selectively engaged with the work piece; and a laser marking unit mounted on a carriage, with the laser marking unit selectively engaged with the work piece.

One embodiment of the present integrated glass cutting and laser marking table has separate bridges and carriages with the glass cutting head and the laser marking unit on separate carriages. A second embodiment of the present invention has a common bridge and separate carriages for the glass cutting head and the laser marking unit. A third embodiment of the present invention has a common bridge and a common carriage for the glass cutting head and the laser marking unit. The present invention also discloses that a laser marking unit may be easily retrofitted onto and integrated with existing cutting tables.

In the embodiments of the invention wherein at least two carriages are provided each carriage is moveable along the length of an associated single bridge to which it is coupled in a direction generally transverse to the length of the main table. A single bridge and two carriages may be provided with the two carriages movable along the single bridge. The two carriages may be on opposite sides of the single bridge in the lengthwise direction of the main table in a first arrangement and the two carriages may be on the same side of the single bridge in the lengthwise direction of the main table in a second orientation. With two separate carriages, a priority or hierarchy in control between the carriages may be provided to prevent the carriages from interfering with each other.

The present invention provides a method of retrofitting a glass cutting table. The glass cutting table will have at least a main table for transporting the glass work piece to be cut, at least one movable bridge extending across the main table, wherein each bridge is movable along the length of the air float table, at least one a carriage moveable along the length of each bridge, and a glass work piece cutting head mounted on a carriage, the cutting head selectively engaged with the work piece. The method includes the step of mounting a laser marking unit on a bridge mounted movable carriage, with the laser marking unit selectively engaged with the work piece. In one embodiment the carriage holding the laser marking unit is separate from the carriage mounting the cutting head, whereby the method would further includes the step of mounting the carriage to which the laser marking unit will be mounted onto a bridge of the table. In one embodiment the bridge holding the carriage holding the laser marking unit is separate from the bridge holding the carriage mounting the cutting head, whereby the method further includes the step of mounting a bridge to which the laser mounting unit carriage will be mounted onto the table.

These and other advantages of the present invention will be clarified in the description of the preferred embodiment together with the attached figures were like reference numeral represent like elements throughout.

### BRIEF DESCRIPTION OF THE DRAWINGS

FIG. 1 is a schematic view of a glass processing line having an integrated glass cutting and laser marking table according to a first embodiment of the present invention;

FIG. 2 is a schematic view of a glass processing line having an integrated glass cutting and laser marking table according to a second embodiment of the present invention; and

FIG. 3 is a schematic view of a glass processing line having an integrated glass cutting and laser marking table according to a third embodiment of the present invention.

### DESCRIPTION OF THE PREFERRED EMBODIMENTS

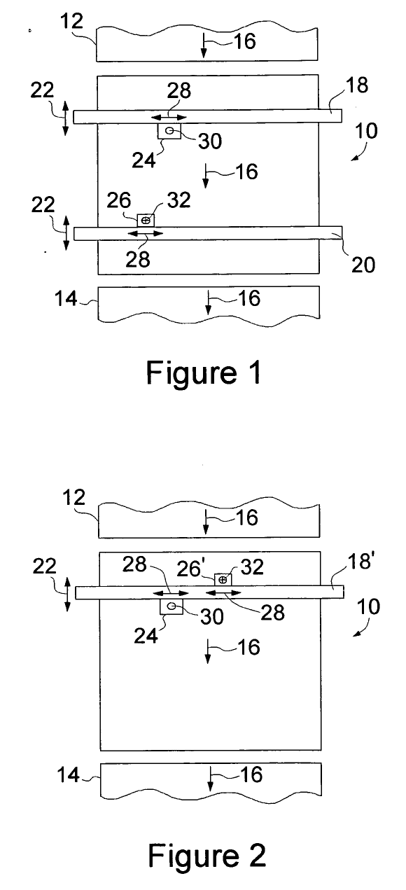

FIGS. 1-3 illustrate glass processing lines incorporating different embodiments of the integrated glass cutting and laser marking table 10 according to the present invention. Turning to FIG. 1, glass work pieces are fed to the integrated table 10 from a feeding table 12 and a transported from the integrated table 10 onto conveyor or feed table 14 thereby defining the feed direction shown by arrow 16. The feed direction 16 also defines the length or longitudinal axis of the table 10. The feeding tables 12 and 14 may be air float tables, roller conveyors or other conveying stations as known in the art. Appropriate conveying tables and systems are available from Billco Industries, Inc.

The table 10 may be formed as a steel tubing frame member supporting an air float table or a conveyor roller table that transports the glass work piece to be cut to an appropriate spot on the table surface for processing. Retractable, powered, conveyor belts may be used for glass transportation. A first bridge 18 extends across the air float or conveyor table. A vacuum or vent in the air float table may be used to hold the work piece for scoring, also known as cutting, as known in the art. Other work piece locating and holding devices may also be used such as mechanical retractable stops. A second bridge 20 also extends across the air float or conveyor table. The first bridge 18 is movable along the length of the air float table as shown by arrow 22, such as by a linear motor beneath the surface of the table. The second bridge 20 is similarly movable along the length of the air float table as shown by arrow 22, and may utilize the same track beneath the surface of the table. The bridges 18 and 20 may be formed as high strength aluminum frame structures that utilize Billco Manufacturing, Inc.'s MagnaDrive™ linear motor system. With two bridges 18 and 20 moveable along the table the controller (not shown) must prevent interference between the bridges to avoid collision there between. The controller may be a GE/Fanuc CNC control with conventional operator interface (e.g. keyboard and/or touch screen). Further the track must be sufficiently long to allow each bridge 18 or 20 to provide complete access to the other bridge 20 or 18 across the working surface of the table. One bridge 18 or 20 may be given priority of position by the controller meaning that the other bridge 20 or 18 will not be moved to a designated location until the priority bridge 18 or 20 is sufficiently out of the way. The priority of the relative bridges 18 and 20 may switch to increase efficiency. A simple illustration of a possible priority is that the second bridge is not moved unless the first bridge is at a “safe zone” at an extreme end of the table.

The first bridge 18 includes a first carriage 24 while the second bridge 20 includes a second carriage 26. Each carriage 24 and 26 is moveable along the length of the associated bridge 18 and 20 transverse to the length of the air float table as shown by arrow 28. The bridge and carriage arrangement provides two separate X-Y positioning members on the table 10, each of which can be separately operated utilizing Billco Manufacturing, Inc.'s MagnaDrive™ linear motor system. The operation of each is not entirely independent from each other since the relative positions of the tooling must be considered and will restrict respective carriage and bridge movement. The construction, operation and control of each independent bridge and carriage is already well known in the art.

The first carriage 24 holds a glass work piece cutting head 30, also called a glass scoring head, for processing or cutting the glass work piece according to a predetermined pattern. The carriage 24 will have a movement mechanism, such as a solenoid or a ball screw mechanism, for vertically moving the scoring head 30 into and out of engagement with the work piece on the table surface. The cutting head 30 may be a pneumatic head for controlling cutting pressure together with a mechanism, e.g. a servomotor, for rotating the cutting wheel. The cutting head 30 may be formed as the Billco Manufacturing, Inc. z95 Superhead™ system.

The second carriage 26 holds a laser marking unit 32, such as a CO2 laser, for marking (etching or engraving) the glass work piece according to a predetermined pattern. The carriage 26 may have a movement or engagement mechanism, such as a solenoid, for vertically positioning the laser of the laser marking unit 32 in proper engagement with the work piece on the table surface. Specifically the laser marking unit 32 may be formed with a 30 W CO2 air cooled industrial grade laser, a high definition marking head with a 75 mm marking field, a digital servo motor ball screw system for raising and lowering the laser, and a safety shield and glass detection device for safety. The laser marking unit can be used for placing logos, decorative finishes, I.D. marks, bar codes and the like on glass work pieces without a separate processing station. The laser marking unit 32 provides an integrated seamless processing operation. A variety of commercially available laser marking units may be utilized.

Existing cutting tables may be easily retrofitted to form the integrated table 10 of FIG. 1 by adding a separate bridge 20, carriage 26 and marking unit 32 together with the controls therefore and the priority to prevent interference between the tooling components.

FIG. 2 is a schematic view of a glass processing line having an integrated glass cutting and laser marking table 10 according to a second embodiment of the present invention. The table of FIG. 2 is the same as the table 10 of FIG. 1 described above except that the first bridge 18′ is modified to have both the first carriage 24 and the second carriage 26 moveably mounted thereon. The second bridge 20 is omitted in this embodiment. The carriages 24 and 26 may be on opposite sides of the bridge 18′ which, if two separate tracks are provided, would allow the carriages to be completely independently movable along the bridge 18′. The carriages 24 and 26 may also be on the same track and/or on the same side of the bridge 18′, which would require a priority of movement hierarchy between the carriages to prevent interference there between.

Existing cutting tables may also be easily retrofitted to form the integrated table 10 of FIG. 2 by adding a carriage 26 and marking unit 32 onto the existing or modified bridge 18′, together with the controls therefore and the priority to prevent interference between the tooling components.

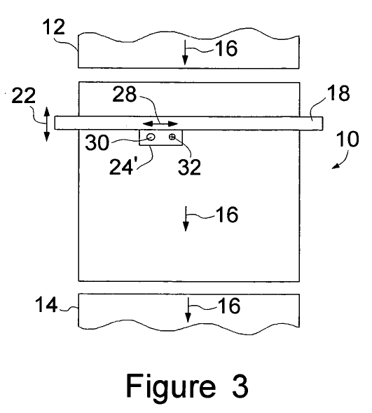

FIG. 3 is a schematic view of a glass processing line having an integrated glass cutting and laser marking table 10 according to a third embodiment of the present invention. The table of FIG. 3 is the same as the table 10 of FIG. 2 described above except that the first carriage 24′ of the first bridge 18 is modified to have both the cutting head 24 and the laser marking unit 32 thereon. The second bridge 20 and the second carriage 26 are omitted in this embodiment. Existing cutting tables may also be easily retrofitted to form the integrated table 10 of FIG. 2 by adding a carriage 26 and marking unit 32 onto the existing or modified bridge 18′, together with the controls therefore. In this embodiment it is likely that only one of the cutting head 24 and the laser marking unit 32 may be operational at any given time.

Various modifications of the present invention may be made without departing from the spirit and scope thereof. The described embodiment is not intended to be restrictive of the present invention. The scope of the present invention is intended to be defined by the appended claims and equivalents thereto.

What is claimed is:

1. A glass cutting and laser marking table comprising:
a main table for transporting the glass work piece to be cut;
at least one bridge extending across the main table, wherein each bridge is movable along the length of the main table;
at least one a carriage moveable along the length of each bridge in a direction generally transverse to the length of the main table;
a glass work piece cutting head mounted on a carriage, the cutting head selectively engaged with the work piece; and
a laser marking unit mounted on a carriage, with the laser marking unit selectively engaged with the work piece.

2. The table of claim 1 wherein at least two carriages are provided, wherein each carriage is moveable along the length of an associated bridge to which it is coupled in a direction generally transverse to the length of the main table, wherein the glass cutting head and the laser marking unit are attached to separate carriages.

3. The table of claim 2 wherein a single bridge and two carriages are provided and the two carriages are movable along the single bridge.

4. The table of claim 3 wherein the two carriages are on opposite sides of the single bridge in the lengthwise direction of the main table.

5. The table of claim 3 wherein the two carriages are on the same side of the single bridge in the lengthwise direction of the main table.

6. The table of claim 2 further including a priority between the carriages to prevent the carriages from interfering with each other.

7. The table of claim 2 wherein two bridges are provided with one carriage on each bridge.

8. The table of claim 1 wherein one carriage mounted on a single bridge is provided, wherein the carriage is moveable along the length of the single bridge and wherein the glass cutting head and the laser marking unit are attached to the one carriage and are selectively independently operable.

9. A method of retrofitting a glass cutting table having a main table for transporting the glass work piece to be cut, at least one movable bridge extending across the main table, wherein each bridge is movable along the length of the air float table, at least one a carriage moveable along the length of each bridge, and a glass work piece cutting head mounted on a carriage, the cutting head selectively engaged with the work piece, said method comprising the step of mounting a laser marking unit on a bridge mounted movable carriage, with the laser marking unit selectively engaged with the work piece.

10. The method of claim 9 wherein the carriage holding the laser marking unit is separate from the carriage mounting the cutting head, whereby the method further includes the step of mounting the carriage to which the laser marking unit will be mounted onto a bridge of the table.

11. The method of claim 10 wherein the bridge holding the carriage holding the laser marking unit is separate from the bridge holding the carriage mounting the cutting head, whereby the method further includes the step of mounting a bridge to which the laser mounting unit carriage will be mounted onto the table.

12. The method of claim 10 wherein the bridge holding the carriage holding the laser marking unit is the same as the bridge holding the carriage mounting the cutting head.

13. An integrated glass cutting and laser marking table comprising:
an air float table for transporting the glass work piece to be cut;
at least one bridge extending across the main table, wherein each bridge is movable along the length of the air float table;
a first carriage moveable along the length of one bridge in a direction generally transverse to the length of the air float table;
a second carriage moveable along the length of one bridge in a direction generally transverse to the length of the air float table;
a glass work piece cutting head mounted on the first carriage, the cutting head selectively engaged with the work piece; and
a laser marking unit mounted on the second carriage, with the laser marking unit selectively engaged with the work piece.

14. The table of claim 13 wherein two bridges are provided with one carriage on each bridge.

15. The table of claim 13 wherein a single bridge is provided and the two carriages are movable along a single bridge.

16. The table of claim 15 wherein the two carriages are on opposite sides of the single bridge in the lengthwise direction of the main table.

17. The table of claim 15 wherein the two carriages are on the same side of the single bridge in the lengthwise direction of the main table.

18. The table of claim 13 further including a priority between the carriages to prevent the carriages from interfering with each other.
